(19) United States
(12) Patent Application Publication
(10) Pub. No.: US 2022/0117053 A1
(43) Pub. Date: Apr. 14, 2022

(54) METHOD OF OPERATING A DIMMER, DIMMER AND LED LIGHTING UNIT

(71) Applicant: Ellenberger & Poensgen GmbH, Altdorf (DE)

(72) Inventors: Joerg Bressler, Nuernberg (DE); Andrea Dluhosch, Altdorf (DE); Christian Neubert, Fuerth (DE); Fred Zoels, Schwarzenbruck (DE)

(21) Appl. No.: 17/555,750

(22) Filed: Dec. 20, 2021

Related U.S. Application Data
(63) Continuation of application No. PCT/EP2020/060685, filed on Apr. 16, 2020.

(30) Foreign Application Priority Data
Jun. 19, 2019 (DE) 10 2019 208 960.7

(51) Int. Cl. H05B 45/10

(52) U.S. Cl. CPC H05B 45/10

(57) ABSTRACT

A method for operating a dimmer which has an input and an output. An input signal applied to the input is detected, and an output signal is determined from the input signal by way of a non-linear characteristic curve. The output signal is applied to the output. There is also described a dimmer and a lighting unit with an LED unit and a dimmer.

### CROSS-REFERENCE TO RELATED APPLICATION

This application is a continuation, under 35 U.S.C. § 120, of copending International Patent Application PCT/EP2020/060685, filed Apr. 16, 2020, which designated the United States; this application also claims the priority, under 35 U.S.C. § 119, of German Patent Application DE 10 2019 208 960.7, filed Jun. 19, 2019; the prior applications are herewith incorporated by reference in their entirety.

### FIELD AND BACKGROUND OF THE INVENTION

The invention relates to a method for operating a dimmer which has an input and an output. The invention further relates to a dimmer as well as to a lighting unit with a dimmer.

Interior spaces have lighting, regardless of whether they are located in a building or a vehicle, such as a motor vehicle or a boat. In order for the lighting to be customizable to a desired situation and requirements, the lighting is usually connected to a dimmer, so that the lighting brightness can be set. If the lighting as an illuminating means comprises a light bulb, an electrical voltage which is directed to the illuminating means is usually reduced by means of the dimmer. This takes place by means of a variable resistance, for example, which is connected in series with the illuminating means.

However, if the illuminating means is designed as a halogen lamp, the dimmer to be used is a leading edge dimmer or trailing edge dimmer. A specific section at the beginning or at the end of a phase of an alternating voltage applied to the illuminating means is therefore set to 0V in each case, such that an average electrical voltage applied to the illuminating means is reduced. Also, when a direct current is used, a reduction in an average electrical voltage applied to the illuminating means takes place by means of suitable pulse width modulation. In this case, the output signal of the dimmer is a multiplicity of pulses which always have the same electrical voltage. The length of the pulse is selected according to the desired brightness of the illuminating means. In other words, the pulse length is changed. Light bulbs as well as halogen lamps exhibit a linear behavior with respect to the electrical voltages applied to them. In the case of a reduction in the electrical voltage applied to the respective illuminating means by a specific percentage, for example by means of the possible resistance or based on the pulse duration, the brightness is thus reduced by the same percentage.

However, if an LED unit with an LED (light-emitting diode) is used as an illuminating means, the brightness does not change linearly depending on a change in the electrical voltage applied thereto. In the case of an LED, the brightness already increases comparatively sharpy in the case of comparatively low applied electrical voltages, and after a specific brightness has been reached, it only increases comparatively slightly with increasing electrical voltage. This effect is amplified if the LED unit has a parallel capacitance or an integrated constant current source.

In the case of LED units, a deviating method is therefore usually used for setting the brightness. In this method, a constant electrical current is usually used which is set by means of pulse width modulation. A pulse width modulated current signal is thus provided by means of the dimmer which has a plurality of pulses with constant current, wherein the length of the pulse is set depending on the desired brightness. In this case, there is a linear relationship between the pulse width of the electrical current and the brightness of the LED used in each case. The level of the electrical current, i.e. the pulse, must be adjusted to the LED used in each case, such that different dimmers must be used in each case or at least a different setting of the dimmer must be carried out in each case for different LED units. This means that few common parts can be used, which increases manufacturing costs. It is also not possible to switch other loads by means of a dimmer of this type. In other words, if the illuminating means is replaced by another load, it is necessary to also exchange the dimmer, which increases manufacturing costs.

### SUMMARY OF THE INVENTION

The underlying object of the invention is to specify a particularly suitable method for operating a dimmer as well as a particularly suitable dimmer and also a particularly suitable lighting unit, wherein comfort and/or adjustment to different applications is advantageously increased.

With the above and other objects in view there is provided, in accordance with the invention, a method of operating a dimmer, the dimmer having an input and an output, the method which comprises:

detecting an input signal applied to the input of the dimmer;

ascertaining an output signal from the input signal by way of a non-linear characteristic curve; and

applying the output signal to the output of the dimmer.

In other words, the objects of the invention are achieved by the method as outlined, as well as by a dimmer and by a lighting unit which includes the dimmer.

The method is used for operating a dimmer. In particular, it is possible to set an electrical power directed to a load by means of the dimmer. In this case, different settings of the electrical power are suitably possible, wherein the number of different settings is advantageously greater than 2, 3, 4 or 5. The load is preferably an LED unit. In particular, the dimmer is suitable, preferably provided and set up, for operating the LED unit. The LED unit comprises an LED (light-emitting diode). In particular, during operation of the dimmer, a luminosity, i.e. a light intensity with which the LED is lit, is set. The dimmer is suitable, in particular provided and set up, for this purpose. In other words, an energization of the LED is set by means of the dimmer. Alternatively or in combination with this, it is possible to set a further load, preferably an energization of it, by means of the dimmer. In particular, a current supply of the load connected in each case, in particular of the LED unit, is set by means of the dimmer, such that complete interruption of the current supply is also enabled by means of the dimmer. In other words, the dimmer additionally serves as a switch.

The dimmer has an input and an output. In this case, the output is suitable, in particular provided and set up, to be electrically contacted with the load. An energization of the load thus takes place via the output in the assembled state. The input is advantageously connected to a switch or another operating unit in the assembled state, such that a user actuation is directed to the dimmer via the input. In particular, the creation of the user actuation takes place by means of the operating unit, for example a switch or a touchpad. Alternatively to this, a control device is connected to the input. For example, a bus system is connected to the input. In each case, the input is suitable, in particular provided and set up, for these requirements.

The dimmer is a component of a current supply system, for example, in particular of a central or decentralized current supply system. In this case, the current supply system, hereinafter in particular also merely referred to as current supply, advantageously has a plurality of outputs, wherein in the assembled state, a load is in each case electrically connected to one of the outputs. The individual outputs are switched by means of the current supply, such that the respective load is switched by means of it. For example, the current supply has precisely the same number of dimmers as outputs, such that setting the electrical power emitted via the respective output can be set by means of the dimmer allocated in each case. The individual dimmers are preferably identical to one another in construction. For example, the current supply comprises an input which forms the input of the dimmer. Alternatively to this, the input of the dimmer is connected to a control unit of the current supply, such that the dimmer is set by means of the control unit. For example, the current supply unit has a plurality of inputs in this case or merely one individual input, by means of which a suitable user actuation is detected. The invention relates in particular to a current supply system of this type as well as to a method for operating a current supply of this type.

The method makes provision for an input signal which is applied to the input to be detected in a first working step. The input system is applied to the input continually or merely at specific times, i.e. in particular merely for a specific period of time, for example. An output signal is ascertained from the input signal by means of a characteristic curve. The input signal is thus translated into the output signal, for which the characteristic curve is used. The characteristic curve is designed to be non-linear. A change in the input signal by a specific value or percentage thus corresponds to a change in the output signal by a value which deviates from this as well as a percentage which deviates from this. The output signal is applied to the output, such that an energization of the load takes place by means of the output signal.

Owing to the method, it is possible to adjust and in particular to linearize a brightness curve during the energization of the possible LED unit. In this case, the changes in the input signal by a specific percentage correspond in particular to the change in the brightness of the LED unit by the same percentage, for which the output signal is changed by a percentage which deviates from this. Intuitive operation and setting of the LED unit is thus made possible, which increases comfort. Therefore, it is also possible for the dimmer for different LED units. Furthermore, it is possible to operate further loads by means of the dimmer, such that the dimmer's field of application is increased.

It is possible to use the dimmer for different applications by modifying the characteristic curve. It is also possible to use the dimmer for different LED units which comprise different LEDs in each case which each have a specific brightness curve. By adjusting the characteristic field, it is possible to select a desired brightness curve for these depending on the input signal.

Ascertaining the output signal advantageously takes place by means of a control unit, by means of which the complete method or at least one part of the method are carried out, for example. The control unit is advantageously designed digitally and has a microprocessor, for example, which is preferably designed to be programmable. Alternatively, or in combination with this, the control unit comprises an ASIC (application specific integrated circuit). The characteristic curve is suitably stored in a storage device of the control unit. A plurality of characteristic curves of this type are advantageously stored in the storage device which, for example, are selected depending on the LED unit used in each case. For example, the selection takes place automatically or by means of programming. The characteristic curve is preferably a component of a characteristic field. It is therefore possible, in addition to the input signal, to take other factors into account, depending on which the output signal is created. One of the other factors is the LED unit used and/or current environmental conditions, for example. One other factor is a currently applied (electrical) supply voltage, for example.

The output signal is preferably an electrical voltage which is thus set by means of the dimmer. It is therefore possible to operate a multiplicity of different loads by means of the dimmer. Provided that the output signal assumes a value of 0 V in the case of at least one of the values of the input signal, it is possible to switch the load by means of the dimmer, i.e. to completely end a current supply, which further increases the scope of application.

For example, the input signal has only a discrete number of different values. A range of values between 0% and 100% is particularly preferably used for the input signal. Consequently, the input signal can thus assume a value of 0% and a value of 100% as well as advantageously further intermediate values. In particular, if the input signal has a value of 0%, there is no energization of the possible connected load, such that the output signal is advantageously also 0 (zero). If the input signal has a value of 100%, the output signal is in particular the maximum possible, such that an energy flow to the possible load is maximized. The complete range of values is thus also covered in the case of the output signal. Alternatively to this, in the case of an input signal of 0%, the output signal is also different from 0 (zero), and/or in the case of an input signal of 100%, the output signal does not correspond to the fully possible one. Overloading the possible load connected to the output is thus avoided.

An analog input signal is used, for example. In this case, an A/D converter is suitably present, by means of which the analog input signal is converted into a digital word. In particular, detection takes place in this case by means of the A/D converter or by means of an interface connected downstream of it, which interface is advantageously formed by means of the possible control unit. An electrical voltage is preferably used as an input signal. For example, an electrical voltage of 0 V corresponds to the input signal of 0%. If the input signal reaches a specific nominal value, in particular a specific electrical nominal voltage, the input signal is in particular equal to 100%. It is therefore possible to create the input signal by means of an analog component, in particular a variable resistance, which reduces complexity.

In one further alternative, the input signal has only specific discrete values, for example, which are advantageously realized by means of a switchable resistance. In this case, a number of switching steps is advantageously present, wherein a specific electrical resistance is allocated to each switching step, by means of which the electrical voltage which is applied to the input is suitably set. In one alternative to this, a digital input signal is used as an input signal. The input signal is in particular made up of a number of pulses which are created manually, for example. With each pulse, the value of the input signal is increased by a specific value, for example 5% or 10%. The value of 100% is thus realized for the input signal by creating the pulse 10 times.

The output signal is an analog signal, for example, which has a substantially constant electrical voltage. However, the output signal is particularly preferably a pulse width modulated electrical voltage. The output signal thus has a plurality of pulses which each have a constant level, i.e. a constant electrical voltage. The length of the pulse, i.e. the pulse/pause ratio, is in particular determined depending on the input signal as well as based on the non-linear characteristic curve. This reduces losses as a result of the adjustment of the electrical voltage applied to the output as an output signal. In one further alternative, a pulse density modulated electrical voltage is used for the output signal. In other words, a pulse density modulation (PDM) is used instead of pulse width modulation (PWM).

The creation of the output signal suitably takes place by means of a switching element, in particular a semiconductor switch. The frequency for confirming the switch, in particular provided that the pulse width modulation or the pulse density modulation is used, is preferably greater than 50 Hz, greater than 1 kHz, greater than 10 kHz or greater than 100 kHz. The individual switching processes are therefore not perceptible by a human, which increases comfort. The length of successive pulses of the pulse width modulated electrical voltage as well as the length of the intermediate pauses is suitably constant, provided that there is no change to the input signal. The pulse width modulated electrical voltage thus has a duty cycle which corresponds in particular to the ratio of the length of one of the pulses to the sum of the length of the pulse and the subsequent distance to the next pulse. The duty cycle is advantageously between 0% and 100%. In the case of a duty cycle of 0%, the electrical voltage applied to the output is constantly 0 V, such that there is no energization of the load. As a result, a current flow to the load is interrupted, such that the dimmer serves as a switch. In the case of the duty cycle of 100%, a constant electrical voltage is also applied to the output which, however, is different from 0 V. Also in the case of pulse density modulation, a duty cycle between 0% and 100% is advantageously used, wherein in the case of 0%, the electrical voltage applied to the output is preferably constantly 0 V, and wherein in the case of 100%, the maximum possible electrical voltage is applied to the output. The possible load is thus energized by means of a substantially constant electrical voltage, and an energy flow to the load is maximized.

The characteristic curve is stored in the dimmer when it is manufactured and in particular cannot be modified, for example. However, it is particularly preferable if the characteristic curve can be modified after the dimmer is manufactured, for example on the user side. This makes it possible to customize the dimmer to different requirements after its manufacture and/or after its assembly, which increases flexibility and the scope of application. In other words, it is possible to modify the characteristic curve based on a user input. In summary, the method in particular makes provision for the user input to be detected and for the characteristic curve to be modified based on the user input. The user input is preferably entered into the dimmer via the input. If the input is a digital input, it is therefore possible to feed a corresponding word into the input, based on which the digitally designed control unit is advantageously programmed or at least the digitally stored characteristic field is modified. Alternatively to this, the dimmer suitably has a further interface via which the user input is detected. The interface is therefore a user interface and is connected or can be connected directly to the dimmer, for example. The user interface is a component of the dimmer, for example. Alternatively to this, a line is connected to the interface, for example a line of a bus system. It is therefore also possible to set the dimmer remotely.

The characteristic curve is modified by means of the user input itself, for example. The user input advantageously comprises the characteristic curve which is stored in the possible storage device of the control unit. However, the characteristic curve already stored is at least modified, preferably overwritten, based on the user input. The characteristic curve is stored on a storage medium, for example, and is read in from this based on the user input. Alternatively to this, an input of the characteristic curve takes place by means of selection from a number of characteristic curves stored in the storage device. It is therefore possible, after assembling the dimmer and/or assembling the possible LED unit, to select the characteristic curve which corresponds to the LED unit in each case from a multiplicity of characteristic curves.

Alternatively to this, the creation of the LED characteristic curve takes place directly by means of the user input. For this purpose, specific knee points or other points of the characteristic curve are entered, for example, preferably by means of a suitable computer program product. In this case, the characteristic curve is particularly preferably output visually, preferably on the user interface which, in particular, is designed as a touchscreen or a separate computer or smartphone. By means of said interface, an output of a representation of the characteristic curve takes place, wherein preferably it can be adjusted accordingly by actuating the touchscreen. This simplifies modification of the characteristic curve for a user and increases comfort. In this case, the characteristic curve already used is in particular firstly indicated by means of the user interface, in particular the touchscreen. This characteristic curve can be modified by touching the touchscreen or by a different actuation of the user interface, wherein the changes are advantageously indicated substantially immediately. This makes intuitive operation and thus intuitive modification of the characteristic curve possible.

Alternatively or in combination with this, the output signal is changed after the user input is detected. The response of a load which is connected to the dimmer is detected by means of a sensor. In this case, the load is advantageously electrically connected to the output of the dimmer, such that if the output signal changes, the energization of the load is also changed. The sensor is, for example, a component of the dimmer or is connected thereto, for example via a suitable interface. Provided that the load is an LED unit, the sensor is advantageously a photo sensor or comprises it. In particular, the characteristic curve is determined based on the response of the load. In particular, the output signal is changed between a minimum value or maximum value, in particular between the duty cycle of 0% and the duty cycle of 100%. For example, the duty cycle is continuously increased from 0% up to 100%, so that the complete range of values of the output signal is run.

The response of the load to the respective output signal is detected by means of the sensor and the characteristic curve is determined from this. In other words, the percentage change of the response of the load to each percentage change of the output signal is in particular determined. Provided that the load is an LED unit, a brightness is advantageously detected by means of the sensor. It is therefore possible to determine from this that the brightness changes by a specific percentage in the case of a multiple change in the output signal.

The output signal and thus the user input is detected if the load is exchanged, for example. In particular, this represents the user input. Alternatively to this, the input of the user input takes place by means of a suitable user interface. In one alternative, the user input is in particular the first start-up of the dimmer. Comfort is therefore increased.

In particular, the dimmer is used to set an energization of a load which is an LED unit, for example. The dimmer is suitable, in particular provided and set up, for this purpose. The dimmer has an input as well as an output. In the assembled state, the load is advantageously electrically connected to the output and is thus connected thereto, preferably by means of a line. The dimmer further has a switching element which is connected to the output. The switching element is a relay or particularly preferably a semiconductor switch, for example, such as a field effect transistor. The switching element is particularly preferably a MOSFET or an IGBT. The switching element is actuated by means of a control circuit which thus represents a driver circuit for the switching element.

Furthermore, the dimmer is operated according to a method in which an input signal which is applied to the input is detected, and an output signal is ascertained from the input signal by means of a non-linear characteristic curve. The output signal is applied to the output. In particular, the switching element is suitably actuated by means of the control circuit for applying the output signal to the output. The dimmer preferably comprises a control unit, by means of which the method is at least partially carried out, and/or by means of which an actuation of the control circuit takes place. The control unit is advantageously designed digitally and has a microprocessor and/or an application-specific circuit (ASIC), for example.

For example, the dimmer is a component of a current supply, for example a central or decentralized current supply. For example, the dimmer is a component of a building or particularly preferably a component of a motor vehicle. For example, the motor vehicle is a land-based motor vehicle, such as a passenger car, a camper, a bus or a truck. Alternatively to this, the motor vehicle may be a boat, for example. During operation, a brightness of an LED unit and thus advantageously illumination of an interior space is in particular set by means of the dimmer.

The switching element is additionally connected to the input of the dimmer, for example. A specific electrical current is thus conducted from the input to the output via the dimmer during operation, wherein influencing by means of the switching element takes place. However, the dimmer particularly preferably has a further output which is suitable, in particular provided and set up, to be connected to a direct current source. In particular, the direct current source is a component of the possible current supply. The switching element is connected between the output and the further output. A current flow from the further output to the output is thus set by means of the switching element, and the input is separate from this and therefore independent. In particular, there is a galvanic isolation between the input and the two outputs, which increases safety.

An electrical direct voltage which provides 9 V, 12 V, 24 V or 48 V is provided by means of the direct current source, for example. A low-voltage network is thus specified, such that an additional transformer is not required in the case of a possible LED unit. In the case of the low-voltage network, it is therefore possible to insert the dimmer in a motor vehicle, wherein a further transformer is not required for connecting to a possible battery or another energy storage device of the motor vehicle. In one alternative, the direct current source is replaced by an alternating current source, by means of which an electrical alternating voltage of 110 V or 220 V is provided, for example. It is therefore possible to use the dimmer for a home installation and thus in a building.

The lighting unit has an LED unit which comprises an LED. The LED unit has a buffer capacitor, for example, or further electrical and/or electronic components, for example a transformer. In addition, the lighting unit comprises a dimmer which has an input and an output. A switching element, which is actuated by means of a control circuit, is connected to the output. The dimmer is operated according to a method in which an input signal which is applied to the input is detected and an output signal is ascertained from the input signal by means of a non-linear characteristic curve. The output signal is applied to the output. In this case, the output of the dimmer is electrically connected to an input of the LED unit, such that an energization of the LED unit takes place by means of the dimmer. Consequently, the output signal is applied to the LED unit, and a brightness of the LED unit is set by means of the dimmer. In this case, it is possible to influence the brightness curve of the LED unit as a result of the non-linear characteristic curve. In addition, the lighting unit preferably comprises a switch which is connected to the input of the dimmer. The switch is a rotary switch or a jog switch, for example, by means of which the input signal is created in each case.

Other features which are considered as characteristic for the invention are set forth in the appended claims.

It should be understood that the developments and advantages explained in the context of the method can also be applied to the dimmer and/or to the lighting unit as well as to each other and vice versa.

Although the invention is illustrated and described herein as being embodied in method for operating a dimmer, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a schematic diagram of a lighting unit with a dimmer;

FIG. 2 is a flowchart illustrating a method for operating the dimmer; and

FIG. 3 shows a further embodiment of the lighting unit similar to FIG. 1.

### DETAILED DESCRIPTION OF THE INVENTION

Mutually corresponding parts are provided with the same reference numbers in all of the figures.

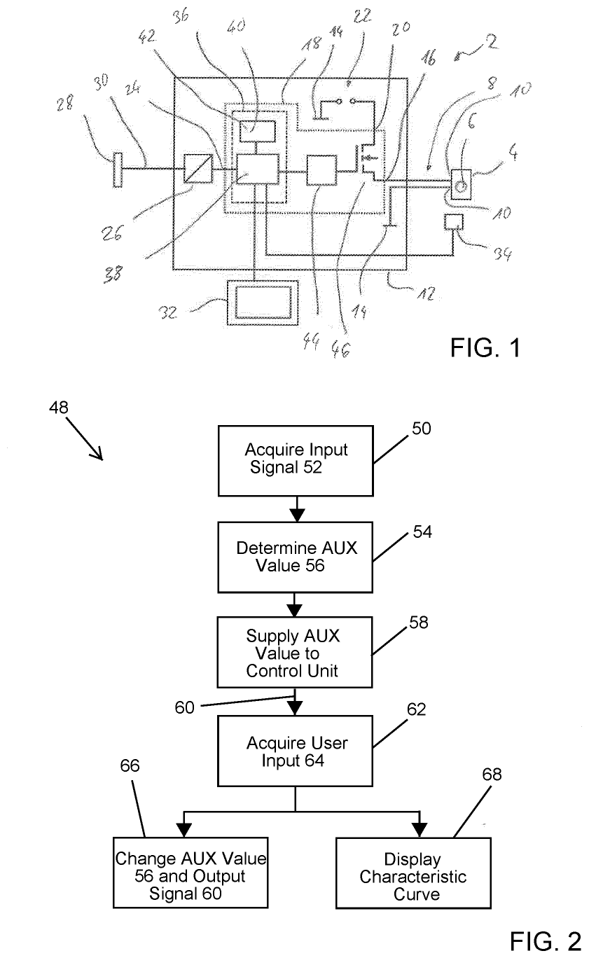

FIG. 1 schematically represents a lighting unit 2 in a simplified manner which has an LED unit 4. The lighting unit 2 is a component of a motor vehicle, namely a boat, and the LED unit 4 comprises an LED (light-emitting diode) 6 as well as further electrical/electronic components which are not represented in greater detail. Two inputs 10 of the LED unit 4 are electrically contacted with a current supply 12, also referred to as a current supply system, by means of a line 8. In this case, one of the inputs 10 is connected to ground 14 by means of the line 8 as well as further components of the current supply 12, which thus represents an electrical reference potential. The further input 10 of the LED unit 4 is connected to an output 16 of a dimmer 18, which is also a component of the current supply 12. The LED unit 4 thus forms a load which is connected to the dimmer 18. The dimmer 18 has a further output 20 which is connected to a direct current source 22, by means of which a direct voltage of 24 V is provided with respect to ground 14. In one variant which is not represented in greater detail, the further output 20 is connected to an on-board power supply of the boat or another external current source.

The dimmer 18 further has an input 24 which is connected to an A/D converter 26 of the current supply 12. A switch 28, which is arranged separately from the current supply 12, is contacted with the A/D converter 26 by means of a further line 30. The switch 28 is a rotary switch, by means of which an electrical resistance can be set, such that an electrical voltage which is applied to the A/D converter can be varied. This analog value of the electrical voltage is converted into a digital word by means of the A/D converter 26, which word has a range of values between 0% and 100%. In this case, the A/D converter 26 is calibrated to the switch 28, such that either 0% or 100% is directed as a value to the input 24 of the dimmer 18 at the two stops of the switch 28. In the case of intermediate positions of the switch 28, a corresponding intermediate value is selected. In this case, there is a linear relationship between the applied electrical voltage and the range of values, such that in the case of a rotation of the switch 28 by a specific percentage, the digital value output by means of the A/D converter is also changed by the same percentage.

Furthermore, the lighting unit 2 has a user interface 32 in the form of a touchpad which is arranged externally to the current supply 12 and is connected to the dimmer 18 in terms of signaling. Furthermore, the lighting unit 2 has a sensor 34 which is designed as a photo sensor. By means of the sensor 34, it is possible to detect a current brightness in the vicinity of the sensor 34. The sensor 34 is arranged in the region of the LED unit 4 and is a component thereof, for example. However, the sensor 34 is at least illuminated by means of the LED 6 in the assembled state. The sensor 34 is also connected to the dimmer 18 in terms of signaling.

The dimmer 18 comprises a microprocessor 36 with a control unit 38 which is provided with corresponding software routines. The microprocessor 36 is connected to the input 24 and therefore to the switch 28 in terms of signaling. The microprocessor 36, and indeed the control unit 38, is also connected to the user interface 32 as well as the sensor 34, such that the signals created as a result can be processed by means of the control unit 38. In this case, the microprocessor 36 or at least the current supply 12 has further A/D converters, such that the signals provided by means of the user interface 32 and/or the sensor 34 are converted into the digital domain. Alternatively to this, digital signals are already provided by means of the user interface 32 and/or the sensor 34. Furthermore, the microprocessor 36 has a storage device 40 in which a non-linear characteristic curve 42 is stored.

A control circuit 44 is operated by means of the control unit 38, which control circuit is also a component of the microprocessor 36 in an embodiment which is not represented in greater detail. The control circuit 44 is used for controlling a switching element 46 which is designed as a semiconductor switch, namely as a MOSFET. The control circuit 44 therefore serves as a driver circuit for the switching element 46. The switching element 46 is connected between the output 16 and the further output 20. The switching element 46 thus makes it possible to set a current flow between the two outputs 16, 20.

The dimmer 18 is operated according to a method 48 which is represented in FIG. 2. In one first working step 50, an input signal 52 which is applied to the input 24 is detected. In this case, the input signal 52 is provided by means of the A/D converter 26 and thus has a range of values between 0% and 100%. In addition, the input signal 52 is a digital word. Detection therefore takes place by means of the control unit 38, by means of which the input 24 is scanned.

In a subsequent second working step 54, an auxiliary value 56 is ascertained by means of the control unit 38 based on the input signal 52. The non-linear characteristic curve 42 is used for ascertaining the auxiliary value 56. In this case, the auxiliary value 56 also has a range of values between 0% and 100% and, provided that the input signal 52 is equal to 0%, the auxiliary value 56 is equal to 0%, and if the input signal 52 is equal to 100%, the auxiliary value 56 is also equal to 100%. However, if the input signal 52 is equal to 50%, for example, the auxiliary value 56 is equal to 40%, wherein an input signal 52 of 70% corresponds to an auxiliary value 56 of 75%.

In a subsequent third working step 58, the auxiliary value 56 is directed to the control circuit 44. The switching element 46 is actuated by means of the control circuit 44, such that by means of said switching element an output signal 60 is applied to the output 16 in the form of a pulse width modulated or pulse density modulated electrical voltage. The output signal 60, i.e. the pulse width modulated electrical voltage, has a duty cycle which is between 0% and 100%. The duty cycle corresponds to the auxiliary value 56, such that a linear conversion of the auxiliary value 56 into the duty cycle of the output signal 60 takes place by means of the control circuit 44. Consequently, if the auxiliary value 56 is equal to 0%, the duty cycle of the output signal 60 is also 0%, and if the auxiliary value 56 is equal to 100%, the duty cycle of the output signal 60 is equal to 100%. In addition, the duty cycle of the output signal 60 is also equal to 64% if the auxiliary value 56 is equal to 64%, for example. This applies to all intermediate values of the auxiliary value 56 and thus also of the duty cycle. In summary, the input signal 52 which is applied to the input 24 is thus detected, and the output signal 60 which is applied to the output 16 is ascertained from the input signal 52 by means of the non-linear characteristic curve 42 using the auxiliary value 56 and corresponding control of the control circuit 44. If the input signal 52 changes, the auxiliary value 56 also changes, wherein, however, there is no linear relationship here. As a result of the changed auxiliary value 56, the output signal 60 changes, specifically in a linear manner.

If necessary, a fourth working step 62 is carried out in which a user input 64 is detected. The user input 64 has been carried out by a user by means of the user interface 64. Depending on the user input 64, either a fifth working step 66 or a sixth working step 68 is carried out.

If the user input 64 results in the fifth working step 66, and in particular a corresponding selection has been made for this, the auxiliary value 56 and therefore also the output signal 60 is changed by means of the control unit 38. In this case, the auxiliary value 56 and thus also the output signal 60, in particular the duty cycle thereof, is varied continuously ascending or descending between 0% and 100%. Consequently, the brightness of the LED 6 is varied between two extreme values, and the resulting brightness of the LED, i.e. its response to this, is detected by means of the sensor 34. An allocation of the brightness value to the respective auxiliary value 56 takes place by means of the control unit 38. The non-linear characteristic curve 42 is determined from this, wherein the brightness value corresponds to the input signal 52. In this case, a linear relationship between the input signal 52 and the brightness is used. It is thus defined in the characteristic curve 42 which value of the input signal 52, i.e. which brightness, corresponds to the respective auxiliary value 56. The characteristic curve 42 ascertained in this way is stored in the storage device 40, so that it is available in the case of the method 48 being carried out again.

In summary, it is determined which auxiliary value 56 corresponds to half the brightness of the LED 6, for example. All of the intermediate values are also determined. The characteristic curve 42 is derived from this, such that a linear relationship between the input signal 42 and the brightness of the LED unit 4, i.e. the LED, is realized when the switch 28 is actuated. Therefore, a position of the switch 28 in a quarter position, i.e. an input signal 52 of 25%, actually also corresponds to a brightness of the LED 6 of 25%, for example. In other words, the user input 64 is detected in the fourth and fifth working step 42, 66, and the characteristic curve 42 is modified based on the user input 64. In this case, the output signal 60 is changed depending on the user input 64, and the response of the load which is connected to the dimmer 18, i.e. the LED unit 4, is detected by means of the sensor 34 and the characteristic curve 42 is determined from this.

However, if the sixth working step 68 is carried out, the current characteristic curve 42 is output visually by means of the user interface 32, so that it is visible to a user. By touching the representation of the characteristic curve 42 on the touchpad 32, it is possible to change it, such that the characteristic curve 42 itself is modified by means of the user input 64. The characteristic curve 42 modified in this way is also stored in the storage device 40, so that it is available in the case of the method 48 being carried out again.

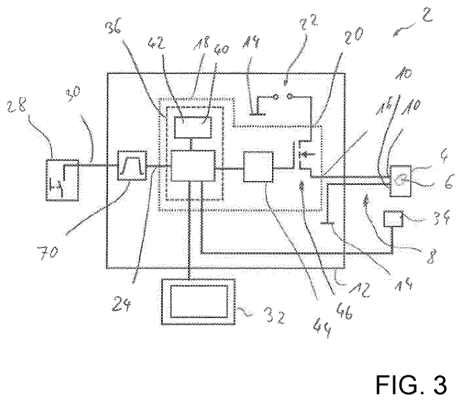

FIG. 3 represents a variation of the lighting unit which is designed to be substantially identical in construction to the variant shown in FIG. 1. However, the switch 28 is changed and is realized as a digital button. Therefore, only pulses are provided by means of the switch 28. The A/D converter 26 is therefore also omitted and is replaced by a ramp generator 70. The number of pulses detected within a specific time window and generated by means of the switch 28 is detected by means of the ramp generator 70 and a specific digital word is created from this, the range of values of which is also between 0% and 100%. In this case, a set of four pulses corresponds to an input signal 52 of 40% and a set of seven pulses corresponds to an input signal 52 of 70%, for example. In other words, each pulse corresponds to an increase in the input signal 52 by 10%.

However, if the pulse exceeds a specific time period, for example 3 seconds, an input signal 42 of 0% is generated. Provided that a pulse with a comparatively great length, i.e. over 3 seconds, is subsequently detected again, the last preceding input signal which was different from 0%, i.e. 70%, for example, is used as an input signal 52. However, if the pulse lasts for a comparatively short time, 10% is used as an input signal 52. With each new pulse, the input signal 52 is increased by 10% respectively. With the exception of the variation of the switch 28 as well as the exchange of the A/D converter 26 for the ramp generator 70, the lighting unit 2 is not modified, such that it is operated in particular according to the method 48 shown in FIG. 2.

In summary, the current supply 12 includes the dimmer 18 which comprises the microprocessor 36, by means of which the computer-implemented method 48 is thus carried out. The input signal 52 is provided by means of the switch 28 and by means of the A/D converter 26 or the ramp generator 70, which input signal is between 0% and 100% and the creation of which takes place in a linear manner depending on the actuation of the switch 28 by way of the user. The creation of the input signal 52 either takes place using an analog signal (FIG. 1) or by means of the switch 28 which is switched off as a button as well as the ramp generator 70, by means of which a time-controlled ramp function is carried out (FIG. 3). The non-linearity of the LED 6 is compensated by means of the non-linear characteristic curve 42, which represents a conversion table, such that a linear relationship between the actuation of the switch 28 and the brightness of the LED 6 is realized.

The characteristic curve 42 is permanently set in the storage device 40 or another firmware of the microprocessor 36, for example. In one alternative, it is possible to create/modify the characteristic curve 42 by means of the user interface 32, wherein a configuration software is preferably used. It is therefore possible to set and thus to configure the dimmer 18 to the LED 6 used in each case. In particular, a graphical input of the characteristic curve 42 by means of the user interface 32 is also supported in this case. It is also possible to automatically generate the characteristic curve 42 by means of the sensor 34, provided that it is present. In this case, the brightness of the LED 6 is measured, i.e. detected, wherein there is a uniform increase in the pulse/pause ratio and thus in the duty cycle of the output signal 60. The correction factors ascertained in this way result in the characteristic curve 42.

The output 16 represents an unregulated switching output of the dimmer 18, which may be used for energizing the LED unit 4. Furthermore, it is also possible to connect further loads to the output 16 and thus to electrically contact it, wherein the use of the characteristic curve 42 is suspended, for example. However, there are, at least, no special requirements for the further load. However, as a result of the characteristic curve 42 when using the LED unit 4, the non-linear increasing brightness is compensated in the case of a linear increase in the duty cycle. In this case, it is possible to use different LED units 4 by adjusting the characteristic curve 42.

It will be understood that the invention is not limited to the exemplary embodiments described above. In fact, other variations of the invention can also be derived from this by the person skilled in the art, without departing from the subject matter of the invention. In particular, all individual features described in the context of the individual exemplary embodiments can furthermore also be combined with one another in a different manner, without departing from the subject matter of the invention.

The following is a summary list of reference numerals and the corresponding structure used in the above description of the invention.
2 lighting unit
4 LED unit
6 LED
8 line
10 input of the LED unit
12 current supply
14 ground
16 output
18 dimmer
20 further output
22 direct current source
24 input
26 A/D converter
28 switch
30 further line
32 user interface
34 sensor
36 microprocessor
38 control unit
40 storage device
42 characteristic curve
44 control circuit
46 switching element
48 method
50 first working step
52 input signal
54 second working step
56 auxiliary value
58 third working step
60 output signal
62 fourth working step
64 user input
66 fifth working step
68 sixth working step
70 ramp generator

1. A method of operating a dimmer, the dimmer having an input and an output, the method which comprises:
detecting an input signal applied to the input of the dimmer;
ascertaining an output signal from the input signal by way of a non-linear characteristic curve; and
applying the output signal to the output of the dimmer.

2. The method according to claim 1, which comprises using a range of values between 0% and 100% for the input signal.

3. The method according to claim 1, which comprises using a pulse width modulated or pulse density modulated electrical voltage which has a duty cycle between 0% and 100% for the output signal.

4. The method according to claim 1, which comprises detecting a user input and modifying the characteristic curve based on the user input.

5. The method according to claim 4, which comprises changing the characteristic curve based on the user input.

6. The method according to claim 5, which comprises visually outputting the characteristic curve.

7. The method according to claim 6, which comprises changing the output signal changes and detecting a response of a load which is connected to the dimmer by way of a sensor, and determining the characteristic curve based on the response.

8. The method according to claim 4, which comprises changing the output signal changes and detecting a response of a load which is connected to the dimmer by way of a sensor, and determining the characteristic curve based on the response.

9. A dimmer, comprising:
an input and an output;
a switching element connected to said output;
a control unit connected to actuate said switching element and configured to operate the dimmer in accordance with the method of claim 1.

10. The dimmer according to claim 8, which comprises a further output connected to a direct current source, wherein said switching element is connected between said output and said further output.

11. A lighting unit, comprising:
an LED unit and a dimmer according to claim 8;
said LED unit having an input electrically connected to the output of said dimmer.
